(19) United States
(12) Patent Application Publication
(10) Pub. No.: US 2017/0038232 A1
(43) Pub. Date: Feb. 9, 2017

(54) Automatic Calibration Apparatus and Method Thereof

(71) Applicants: Soon Kwi KIM, Seoul (KR); Sang Hwan JANG, Seoul (KR)

(72) Inventors: Soon Kwi KIM, Seoul (KR); Sang Hwan JANG, Seoul (KR)

(73) Assignee: Kisan Electronics Co., Ltd., Seoul (KR)

(21) Appl. No.: 15/227,547

(22) Filed: Aug. 3, 2016

(30) Foreign Application Priority Data
Aug. 5, 2015 (KR) 1020150110667

(51) Int. Cl. G01D 18/00; G07D 7/02; G07D 7/08

(52) U.S. Cl. CPC G01D 18/002; G07D 7/08; G07D 7/026

(57) ABSTRACT

An automatic calibration apparatus and method are disclosed. The automatic calibration apparatus includes a transmitter configured to output a transmission signal, a receiver configured to receive the signal output from the transmitter, and a controller configured to generate the transmission signal at a predetermined frequency to be output by the transmitter, and calibrate the transmission signal by analyzing a signal received by the receiver before banknote identification.

This application claims the benefit of Korean Patent Application No. 10-2015-0110667, filed on Aug. 5, 2015, which is hereby incorporated by reference as if fully set forth herein.

### BACKGROUND OF THE INVENTION

Field of the Invention

The present disclosure relates to an apparatus and method for automatic calibration, and more particularly, to an automatic calibration apparatus and method for increasing the accuracy of banknote identification by automatically calibrating a banknote identification sensor when a banknote detector is booted or a banknote is introduced into the banknote detector, or before identifying the introduced banknote.

Discussion of the Related Art

In general, a banknote detector determines whether an introduced banknote is authentic or fit for circulation. For example, the banknote detector determines whether a banknote is fit (e.g., new, worn, or damaged) or counterfeit. Banknotes to be processed may include newly issued ones, old ones, crisp ones, wrinkled ones, folded ones, punctured ones, discolored ones, worn ones, taped ones, and the like.

The term “banknote detector” herein covers any banknote processing device capable of counting as many bills as a user-requested quantity during deposition or withdrawing, and determining the authenticity or fitness of a banknote. Banknote detectors are used in places dealing with banknotes in large quantity or frequently, such as banks, Cash-In-Transit (CIT) companies, currency exchanges, post offices, casinos, large stores, and convenience stores.

However, such a banknote detector may experience a change in the state (e.g., a difference between channels of sensors, a gap between a transmitter and a receiver of sensors) of one or more sensors (e.g., capacitive sensors or ultrasonic sensors) or a change in the performance (e.g., a change of an output signal) of the sensor(s) used for banknote identification due to a changed ambient environment (e.g., temperature, humidity, and impact) or an increased usage time.

Therefore, in response to the change in the state or the performance of the sensor(s), a user or a manager of the banknote detector periodically calibrates or compensates the sensors of the banknote detector to thereby maintain their optimum performance (e.g., accurate identification performance) until expiration of their lifetime. Despite the need for calibration, however, direct calibration by the manager (or the user) is not efficient in terms of time and cost.

The background art is disclosed in Korea Registered Patent No. 10-0812254 (entitled “Paper Money Detector” and registered on Mar. 4, 2008).

### SUMMARY OF THE INVENTION

According to one or more aspects of the present invention, a method and apparatus for automatic calibration may substantially obviate one or more problems due to limitations and disadvantages of the related art.

An aspect of the present invention provides an automatic calibration apparatus and method for increasing the accuracy of banknote identification by automatically calibrating a banknote identification sensor when a banknote detector is booted (e.g., started up) or a banknote is introduced into the banknote detector, or before the banknote detector attempts to identify the introduced banknote.

An aspect of the present invention provides an automatic calibration apparatus and method for reducing a calibration time by selectively performing a specific type of calibration based on an analysis of a received signal.

Other aspects, advantages, and salient features of the disclosure will be set forth in part in the description which follows and in part will become apparent to those skilled in the art upon examination of the following or may be learned from practice of the disclosure. The objectives and other advantages of the disclosure may be realized and attained by the structure(s) particularly pointed out in the written description and claims hereof as well as in the appended drawings.

To achieve these objects and other advantages and in accordance with the purpose(s) of the disclosure as embodied and broadly described herein, an automatic calibration apparatus includes a transmitter configured to output a transmission signal, a receiver configured to receive the signal output from the transmitter, and a controller configured to generate the transmission signal at a predetermined frequency to be output by the transmitter, and calibrate the transmission signal by analyzing a signal received by the receiver before banknote identification.

In another aspect of the present invention, an automatic calibration apparatus includes a transmitter configured to output a transmission signal, a receiver configured to receive the signal output from the transmitter, and a controller configured to generate the transmission signal at a predetermined level and calibrate the transmission signal to a target level by analyzing the level of the transmission signal output by the transmitter before banknote identification.

In another aspect of the present invention, an automatic calibration apparatus includes a transmitter configured to output a transmission signal, a receiver configured to receive the signal output from the transmitter, and a controller configured to generate the transmission signal at a predetermined frequency and perform gain calibration on each channel of the received signal by analyzing the received signal output from the receiver before banknote identification.

In another aspect of the present invention, an automatic calibration apparatus includes a transmitter configured to output a transmission signal, a receiver configured to receiving the signal output from the transmitter, and a controller configured to generate the transmission signal at a predetermined frequency to be output by the transmitter, and performing offset calibration on each channel of a received signal by analyzing the received signal output from the receiver, before banknote identification.

In another aspect of the present invention, an automatic calibration method includes analyzing a level of a signal received in a plurality of channels by a receiver before banknote identification by a controller, and, using the controller, calibrating a level of a transmission signal to be output from a transmitter based on an average level of the channels of the received signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle(s) of the invention. In the drawings:

FIG. 1 is a block diagram of an automatic calibration apparatus according to an embodiment of the present invention;

FIG. 2 is a block diagram of an automatic calibration apparatus according to a second embodiment of the present invention;

FIG. 3 is a block diagram of an automatic calibration apparatus according to a third embodiment of the present invention;

FIG. 4 is a block diagram of an automatic calibration apparatus according to a fourth embodiment of the present invention;

FIG. 5 is a block diagram of an automatic calibration apparatus according to a fifth embodiment of the present invention;

FIG. 6 is a block diagram of an automatic calibration apparatus according to a sixth embodiment of the present invention;

FIG. 7 is a flowchart illustrating an automatic calibration method according to a seventh embodiment of the present invention; and

FIG. 8 is a flowchart illustrating an automatic calibration method according to an eighth embodiment of the present invention.

### DETAILED DESCRIPTION OF THE INVENTION

Embodiments of an apparatus and method for automatic calibration according to the present invention will be described below with reference to the attached drawings.

The thicknesses of lines or the sizes of components may be exaggerated in the drawings, for clarity and convenience of description. Further, the terms as set forth herein may be defined in consideration of functions in the present invention, and they may be different according to the intent of an operator or customs. Accordingly, the terms should be defined based on the overall contents of the present disclosure.

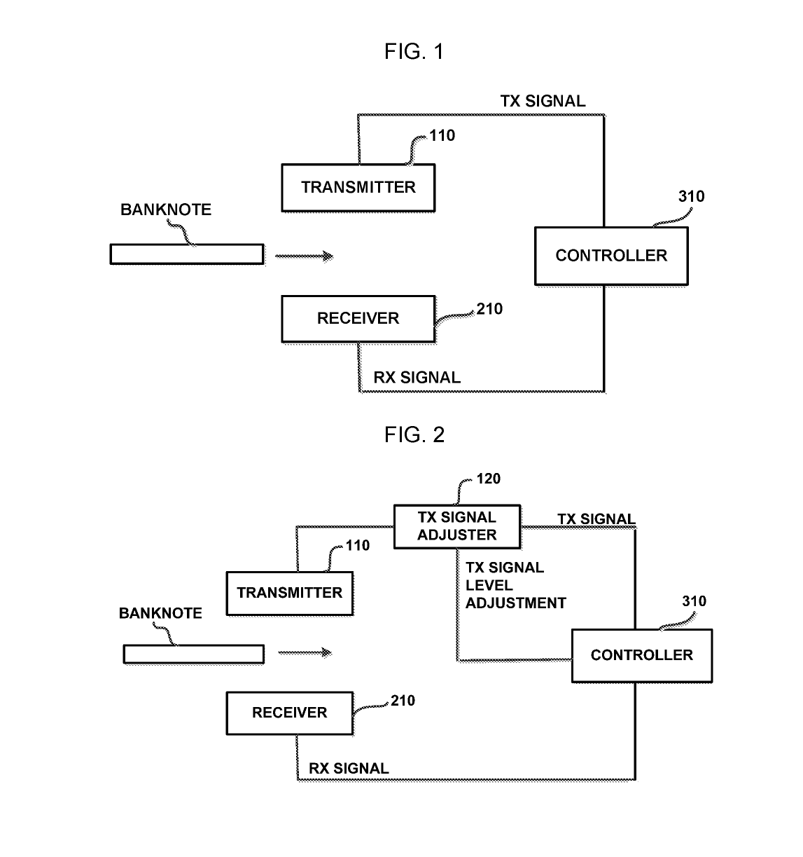

FIG. 1 is a block diagram of an automatic calibration apparatus according to an embodiment of the present invention.

Referring to FIG. 1, the automatic calibration apparatus according to an embodiment of the present invention includes a transmitter 110, a receiver 210, and a controller 310.

In the embodiment of FIG. 1, the automatic calibration apparatus may automatically perform calibration for a banknote detector.

The controller 310 generates a Transmission (Tx) signal at a predetermined frequency (e.g., a few kHz to tens of MHz, preferably 10 kHz to 10 MHz). Before the transmission signal is output by the transmitter 110, the controller 310 may adjust (e.g., raise) the level of the Tx signal to a predetermined level. Also, the controller 310 may measure or analyze the output level of the Tx signal. If the output level of the Tx signal is not a predetermined target value, the controller 310 may control the level of the Tx signal to be the target value.

Further, the level of the Tx signal may be adjusted based on an analysis of a level of a signal received (or detected) by the receiver 210 (that is, level adjustment of Tx signal).

For example, if the average level of the Received (Rx) signal is smaller than a predetermined target value (a first target value) or larger than the predetermined target value (the first target value) by a value equal to or larger than a predetermined reference (e.g., outside a predetermined margin or range), as a result of the level analysis of the Rx signal, the controller 310 may increase or decrease the level of the Tx signal. More specifically, the receiver 210 may receive the signal from the transmitter 110 over a plurality of channels, and the average of the levels of the Rx signal(s) of or over respective channels of the receiver 210 is calculated. A channel outputting an Rx signal having a level closest to the calculated average level (e.g., the average level of the Rx signals) is determined or detected. Then, the level of the Tx signal is increased or decreased so that the level of the Rx signal of the detected channel may become the predetermined target value (the first target value).

The Rx signal received by the receiver 210 is typically attenuated to a very weak level (e.g., tens of μV to hundreds of mV, preferably a few mV to tens of mV), although the attenuation varies depending on the medium (e.g., air, a paper, a banknote, a tape, or a foreign material) between the transmitter 110 and the receiver 210. Therefore, the Rx signal may be amplified to a predetermined signal level (e.g., a few mV to tens of mV) by one or more amplifiers (not shown) so that the Rx signal may be suitable for signal processing (e.g., the Rx signal may have a signal level allowing identification by the controller 310).

The transmitter 110 outputs a Tx signal (or a Tx signal amplified to a specific level) toward the receiver 210, which is generally spaced from the transmitter 110 by a predetermined gap (e.g., a few mm to tens of mm).

Although the transmitter 110 outputs the Tx signal in a different manner according to a banknote identification sensor (e.g., a capacitive sensor, an ultrasonic sensor, an eddy current sensor, or a displacement sensor) applied to the transmitter 110, the calibration method of the embodiment of FIG. 1 is applicable irrespective of the banknote identification sensor used in the transmitter 110 or receiver 210.

The receiver 210 receives (or detects) an output signal that changes when a banknote is between the transmitter 110 and the receiver 210. Hereinafter, the signal received (or detected) at the receiver 210 (i.e., a changed output signal) will be referred to as an Rx signal, distinguishable from the Tx signal.

Also, the receiver 210 may incorporate or include an amplifier (not shown).

Meanwhile, the transmitter 110 and the receiver 210 may have or include a plurality of channels (e.g., CH1 to CH15), and the channels may have different characteristics according to electronic circuit parts used for them. The number of channels (e.g., 4 or more, 8 or more, 16, etc.) may vary with an implementation purpose or an implementation environment.

Accordingly, the controller 310 may further perform gain adjustment or offset adjustment for Rx signals of the respective channels (e.g., CH1 to CH15) so that the sensitivity of the Rx signals (or a receiving signal amplified to a specific level) may be increased (or decreased) and have the same characteristics with respect to the same medium.

For convenience, calibration includes level adjustment of the Tx signal (referred to as Tx signal level adjustment), gain adjustment of the Rx signal (referred to as Rx signal gain adjustment), offset adjustment of the Rx signal (referred to as Rx signal offset adjustment), combinations thereof, and the like in embodiments of the present invention.

While the controller 310 itself is described as responsible for calibration in the above example, the controller 310 may control an individual constitutional component (e.g., a Tx signal level controller, an Rx signal gain controller or an offset controller; not shown) configured to execute a specific function (e.g., Tx signal level adjustment, Rx signal gain adjustment, Rx signal offset adjustment, or the like), so that the calibration (or adjustment) corresponding to the specific function may be executed.

Herein, the controller 310 may perform one or more of the above-described types of calibration sequentially or selectively according to an operation state of the banknote detector or an analysis and/or result of the Rx signal (or the Rx signal amplified to a specific level).

FIG. 2 is a block diagram of an automatic calibration apparatus according to another embodiment of the present invention.

Referring to FIG. 2, the automatic calibration apparatus according to the second embodiment of the present invention further includes a Tx signal adjuster 120 in addition to the components of the automatic calibration apparatus illustrated in FIG. 1.

The automatic calibration apparatus according to the second embodiment of the present invention may perform calibration automatically, for example, when the banknote detector is booted or a banknote is introduced into the banknote detector.

The Tx signal adjuster 120 adjusts the level of a Tx signal to be output from the transmitter 110 under control of the controller 310. For example, the Tx signal adjuster 120 may receive a measurement result or an analysis result of the output level of the Tx signal output from the controller 310. If the output level of the Tx signal is not a predetermined target value, the Tx signal adjuster 120 may adjust the level of the Tx signal to the target value. The level-adjusted Tx signal is output to the receiver 210 by the transmitter 110.

The level of the Tx signal may be adjusted to between a few V to tens of V. However, the level setting range of the Tx signal is not intended to be limited in embodiments of the present invention.

In the case where the transmitter 110 and the receiver 210 are configured as capacitive sensors, when the level-adjusted Tx signal is applied to the transmitter 110, an electrical field is formed between the transmitter 110 and the receiver 210, and thus electricity is accumulated in or on one side (e.g., the receiver 210) due to attraction between different poles of the capacitor. As the polarization plate of each of the transmitter 110 and the receiver 210 occupies a larger area, as the polarization plates are placed closer to each other, and as an insulator between the polarization plates has a higher dielectric constant, the amount of the accumulated electricity (i.e., capacitance) increases.

The relative permittivity of a material is expressed as a ratio relative to the permittivity of air, 1. In general, a dielectric constant means a relative permittivity. If only air exists between the transmitter 110 and the receiver 210, the dielectric constant is low, thereby flowing less current. If a banknote having a high dielectric constant is introduced between the transmitter 110 and the receiver 210, more current flows than when only air is between the transmitter 110 and the receiver 210. Therefore, the banknote detector identifies a banknote by detecting the change in the current caused by a change in the dielectric constant, which varies according to the type and/or characteristic of a banknote (e.g., the state of the banknote, whether the banknote has a foreign material attached thereto, the thickness of the banknote, etc.) introduced between the transmitter 110 and the receiver 210.

In addition, if the transmitter 110 and the receiver 210 are configured, for example, as ultrasonic sensors, the level (or intensity) of a signal detected at the receiver 210 has a unique value in each of the cases where (1) there is no banknote between the transmitter 110 and the receiver 210, (2) a banknote is passing (i.e., there is a banknote) between the transmitter 110 and the receiver 210, (3) the banknote is new, old, taped or damaged, and (4) one or more (e.g., a plurality of) folded (e.g., doubled) banknotes are passing between the transmitter 110 and the receiver 210. Therefore, a banknote can be identified based on a property or characteristic in which the level (or intensity) of the signal detected at the receiver is different in each of the above cases.

Referring to FIG. 2 again, the controller 310 analyzes the level of the Rx signal (or the Rx signal amplified to a specific level) to adjust the level of the Tx signal.

For example, in the absence of a banknote between the transmitter 110 and the receiver 210 such as when the banknote detector is booted or a banknote is introduced into the banknote detector, the controller 310 analyzes the level of the Rx signal received (or detected) by the receiver 210 (or the Rx signal amplified to the specific level).

The controller 310 adjusts the level of the Tx signal based on the analysis and/or result of the Rx signal (or the Rx signal amplified to the specific level) to the Tx signal adjuster 120.

For example, if the level of the Rx signal (or the Rx signal amplified to the specific level) is lower than a predetermined target value (a first target value), the controller 310 increases (or amplifies) the level of the Tx signal to the Tx signal adjuster 120. On the contrary, if the level of the Rx signal (or the Rx signal amplified to the specific level) is higher than the predetermined target value (the first target value) by a value equal to or larger than a predetermined reference, the controller 310 decreases the level of the Tx signal to the Tx signal adjuster 120. More specifically, in one embodiment, the average of the levels of signals received on or over respective channels is calculated, and a channel outputting an Rx signal having a level closest to the calculated average (i.e., the average level of the Rx signals) is detected or determined. Then, the level of a Tx signal is increased or decreased so that the level of the Rx signal of the detected channel may become the predetermined target value (e.g., the first target value).

The Tx signal is applied to all channels (e.g., CH1 to CH15) of the transmitter 110. However, the Rx signal (or the Rx signal amplified to the specific level) is respectively output, while each of the channels (CH1 to CH15) of the receiver 210 is sequentially scanned.

Accordingly, when an Rx signal is mentioned in various embodiments for the convenience of description, the Rx signal may be an Rx signal of each channel.

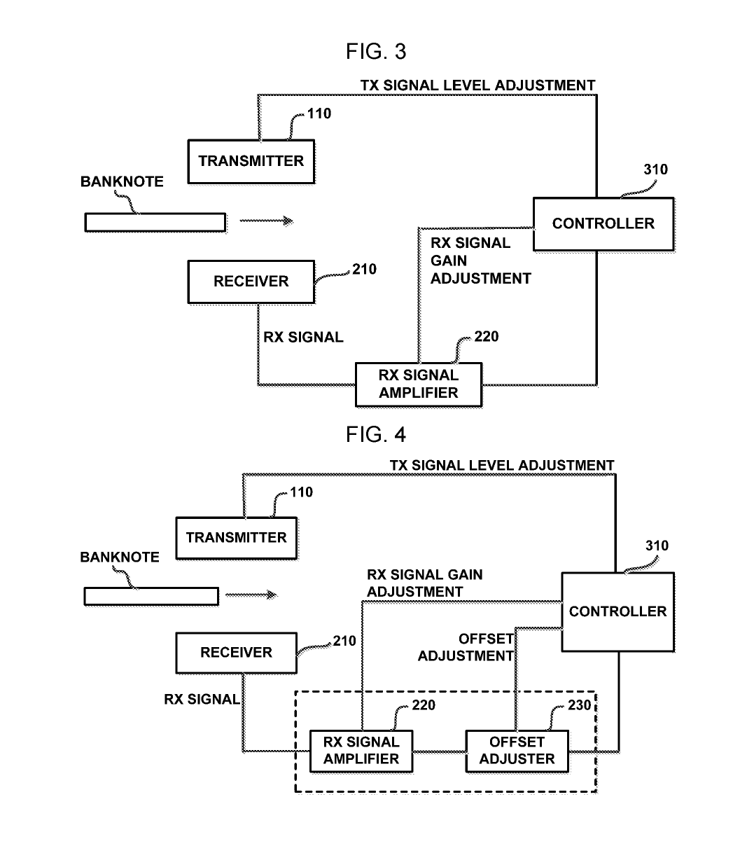

FIG. 3 is a block diagram of an automatic calibration apparatus according to a third embodiment of the present invention.

Referring to FIG. 3, the automatic calibration apparatus according to the third embodiment of the present invention further includes an Rx signal amplifier 220 in addition to the components of the automatic calibration apparatus illustrated in FIG. 1.

The Rx signal amplifier 220 amplifies signals of all channels (or signals amplified to a desired level) received or detected by the receiver 210 to a predetermined level (e.g., by a few times to a few thousand times).

The Rx signals may be signals amplified to a specific level (e.g., by a few times) by an amplifier (not shown) in the receiver 210.

The Rx signal amplifier 220 may be configured, for example, as an operational amplifier (OP AMP).

The controller 310 adjusts the gain of the Rx signal on a channel basis through the Rx signal amplifier 220 to amplify the level of the Rx signal (or the received signal amplified to the desired level); that is, the levels of the Rx signals of all channels may be adjusted to a predetermined target value (a first target value). this may be considered to be Rx signal gain adjustment.

Also, the controller 310 analyzes the average level of the Rx signals amplified by the Rx signal amplifier 220.

If the average level of the Rx signals amplified by the Rx signal amplifier 220 is lower than or larger than the predetermined target value (the first target value) by a value equal to or larger than a predetermined reference, as a result of the average level analysis of the amplified Rx signals, the controller 310 may increase or decrease the level of the Tx signal so that the level of an Rx signal may approach, match or become the target value.

In a specific method for increasing or decreasing the level of the Tx signal, for example, the controller 310 calculates the average of the levels of the Rx signals over all of the channels (e.g., the average of signals of CH1 to CH15) and detects a channel (e.g., CH3) outputting an Rx signal having a level closest to the calculated average level. Then, the level of the Tx signal is increased or decreased so that the level of the Rx signal on the detected channel (e.g., CH3) may become the predetermined target value (the first target value).

If the Tx signal level adjustment (e.g., level calibration) fails (e.g., the level of the Rx signal does not reach the target value or exceeds the target value), the controller 210 changes (increases or decreases) the target value (the first target value), and then performs the Tx signal level adjustment (e.g., the level calibration) again.

The Tx signal level adjustment (e.g., the Tx signal level calibration or first calibration) and the Rx signal gain adjustment (e.g., Rx signal gain calibration or second calibration) may be repeated. The two types of calibration may be performed sequentially or in a reverse order, or only one of the two types of calibration may be selectively performed.

Meanwhile, for the same dielectric material placed (or introduced) between the transmitter 110 and the receiver 210, signals of the respective channels (e.g., CH1 to CH15) received at the receiver 210 should have the same characteristics (e.g., for the same dielectric material, an Rx signal of each channel should be attenuated at the same rate and thus have the same Rx signal level).

Therefore, even though the levels of the Rx signals of each channel are equal to or higher than the target value (the first target value) through the Tx signal level adjustment (e.g., Tx signal level calibration) and the Rx signal gain adjustment (e.g., Rx signal gain calibration), offset adjustment (e.g., offset calibration) may be needed.

In the calibration scheme of the third embodiment, the first and second calibrations may be performed together when the banknote detector is booted. When the banknote is introduced after booting the banknote detector (or during a time period from introduction of the banknote to banknote identification), only the second calibration may be performed.

FIG. 4 is a block diagram of an automatic calibration apparatus according to a fourth embodiment of the present invention.

Referring to FIG. 4, the automatic calibration apparatus according to the fourth embodiment of the present invention further includes an offset adjuster 230 in addition to the components of the automatic calibration apparatus illustrated in FIG. 3.

The offset adjuster 230 adjusts the offset of an Rx signal amplified to a predetermined target value (a first target value) by the Rx signal amplifier 220.

That is, the controller 310 performs offset adjustment (e.g., offset calibration, which may be referred to as a third calibration) by the offset adjuster 230 so that the Rx signal of each channel amplified to the predetermined target value (the first target value) by the Rx signal amplifier 220 may have the same target value (a second target value). for example, for the same dielectric material, the Rx signal of each channel may be attenuated at the same rate and thus have the same Rx signal level.

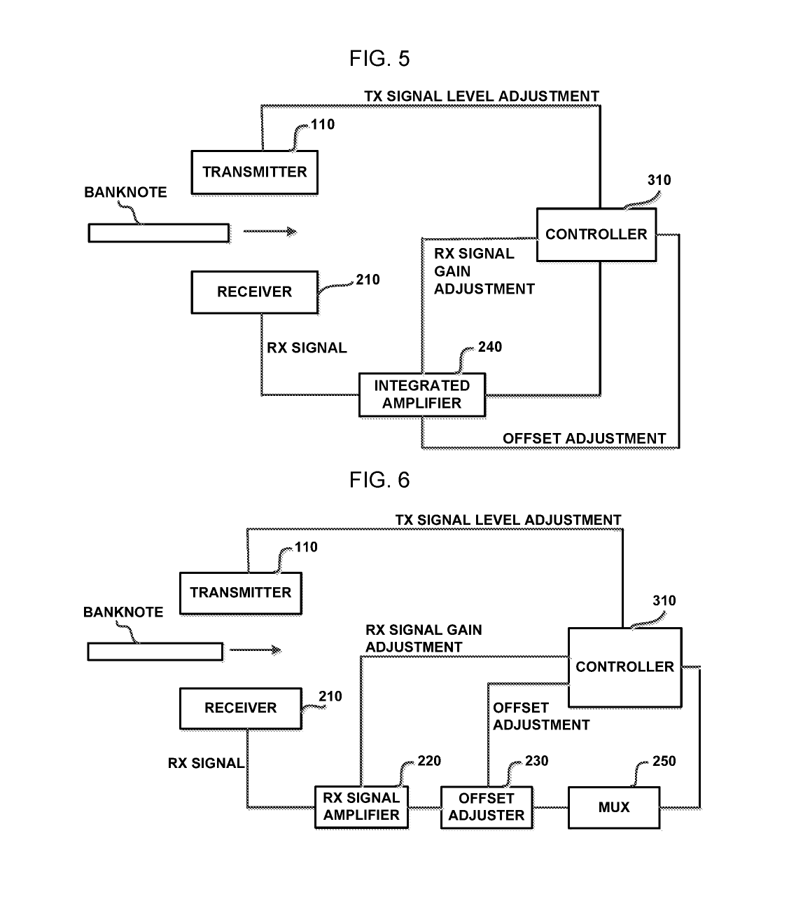

While it has been described in the embodiment of FIG. 4 that the Rx signal amplifier 220 and the offset adjuster 230 are separately configured, and Rx signal gain adjustment and offset adjustment are performed separately by the components 220 and 230, the Rx signal amplifier 220 and the offset adjuster 230 may be incorporated into a single module in another embodiment (see FIG. 5).

Further, in the calibration scheme of embodiments of the present invention, when the banknote detector is booted, the first and second calibrations or the first, second, and third calibrations may be performed together. When the banknote is placed on an inlet (or is introduced into a sensor) after booting the banknote detector (or during a time period from banknote introduction to banknote identification), the second calibration, or the second and third calibrations may be performed.

FIG. 5 is a block diagram of an automatic calibration apparatus according to a fifth embodiment of the present invention.

Referring to FIG. 5, the automatic calibration apparatus according to the fifth embodiment of the present invention includes an integrated amplifier 240 in which the Rx signal amplifier 220 and the offset adjuster 230 of the automatic calibration apparatus illustrated in FIG. 4 are incorporated.

Accordingly, the integrated amplifier 240 amplifies (e.g., adjusts the gain of) an Rx signal of each channel to the predetermined target value (the first target value) (e.g., the second calibration), and performs offset adjustment so that the Rx signals amplified to the target value (the first target value) may have the same target value (a second target value) (e.g., the third calibration, wherein for the same dielectric material, the Rx signal of each channel may be attenuated at the same rate and thus have the same Rx signal level).

In the calibration according to the fifth embodiment of the present invention, the first and second calibrations or the first, second, and third calibrations may be performed together when the banknote detector is booted, and the second calibration or the second and third calibrations may be performed when the banknote is introduced in the inlet after booting the banknote detector (or during a time period from banknote introduction to banknote identification).

FIG. 6 is a block diagram of an automatic calibration apparatus according to a sixth embodiment of the present invention.

Referring to FIG. 6, the automatic calibration apparatus according to the sixth embodiment of the present invention further includes a multiplexer (MUX) 250 in addition to the components of the automatic calibration apparatus illustrated in FIG. 4.

The MUX 250 multiplexes the Rx signals of the channels on which gain adjustment (e.g., Rx signal gain calibration) and offset adjustment (e.g. offset calibration) have been completely performed, and outputs the multiplexed signal.

For example, if the receiver 210 includes 15 channels, the MUX 250 outputs detected signals of the respective channels (e.g., all of the 15 channels) selectively or serially.

While the foregoing embodiments have been described above with reference to the attached drawings, they may be implemented in combination.

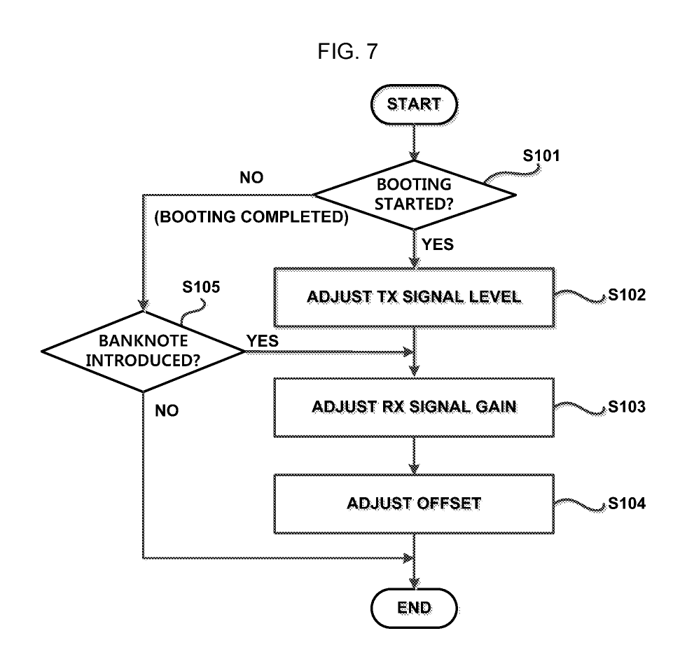

FIG. 7 is a flowchart illustrating an automatic calibration method according to a seventh embodiment of the present invention.

Referring to FIG. 7, if a device (e.g., a banknote detector) is turned on and starts to be booted (YES in operation S101), the controller 310 performs Tx signal level adjustment (e.g., Tx signal level calibration or the first calibration) in operation S102.

For example, for the Tx signal level adjustment (e.g., the Tx signal level calibration), the controller 310 analyzes the average level of Rx signals (or Rx signals amplified to a specific level) before starting to identify a banknote. That is, if the average level of the Rx signals (or the Rx signals amplified to the specific level) is lower than or higher than the predetermined target value (the first target value) by a value equal to or larger than a predetermined reference, the controller 310 increases or decreases the level of the Tx signal. Also, the controller 310 measures or analyzes the level of an output Tx signal. If the level of the Tx signal is not at a target level, the controller 310 may adjust the level of the Tx signal to the target level.

Upon completion of the Tx signal level adjustment (e.g., the Tx signal level calibration), the controller 310 performs Rx signal gain adjustment (e.g., the Rx signal gain calibration or the second calibration) by the Rx signal amplifier 220 in operation S103.

For example, the controller 310 adjusts the gain of each channel in the Rx signal amplifier 220 in order to amplify the levels of the Rx signals (or the Rx signals amplified to the specific level; e.g., the levels of the Rx signals on all channels) to the predetermined target value (the first target value or higher).

Upon completion of the Rx signal gain adjustment (e.g., the Rx signal gain calibration), the controller 310 performs offset adjustment (e.g., offset calibration or the third calibration) by the offset adjuster 230 in operation S104.

For example, the controller 310 adjusts the offset of each channel (e.g., performs offset calibration) by the offset adjuster 230 so that the Rx signal of each channel amplified to the predetermined target value (the first target value) by the Rx signal amplifier 220 may have the same target value (a second target value; e.g., for the same dielectric material, the Rx signal of each channel may be attenuated at the same rate and thus have the same Rx signal level).

On the other hand, if the device (e.g., the banknote detector) has already been booted (i.e., NO in operation S101) and introduction of a banknote is detected in operation S105, only the Rx signal gain adjustment (e.g., the Rx signal gain calibration or the second calibration) is performed without the Tx signal level adjustment (e.g., the Tx signal level calibration or the first calibration) in operation S103. Alternatively, the Rx signal gain adjustment and the offset adjustment (e.g., the offset calibration or the third calibration) are sequentially performed in operations S103 and S104.

Herein, the introduction of the banknote may be detected by a hopper sensor (not shown) in the device (e.g., the banknote detector) in operation S105.

While not shown, if the device (e.g., the banknote detector) has already been booted (i.e., NO in operation S101), even though the banknote is not introduced, the Rx signal gain adjustment (e.g., the Rx signal gain calibration) and/or the offset adjustment (e.g., the offset calibration) may be performed each time a predetermined time elapses or when a user inputs a calibration command (e.g., as desired or needed).

In the foregoing embodiment, when the banknote detector is booted or the banknote is introduced into the banknote detector, specific types of calibration (e.g., the Tx signal level calibration, the Rx signal gain calibration, and/or the offset calibration) may be sequentially performed.

However, the calibrations are not necessarily performed sequentially. Thus, a specific type of calibration may not be performed or the calibrations may be performed in a different order according to an analysis of the levels of the Rx signals (or an analysis of the average level of the Rx signals).

Now, a description will be given of another calibration method.

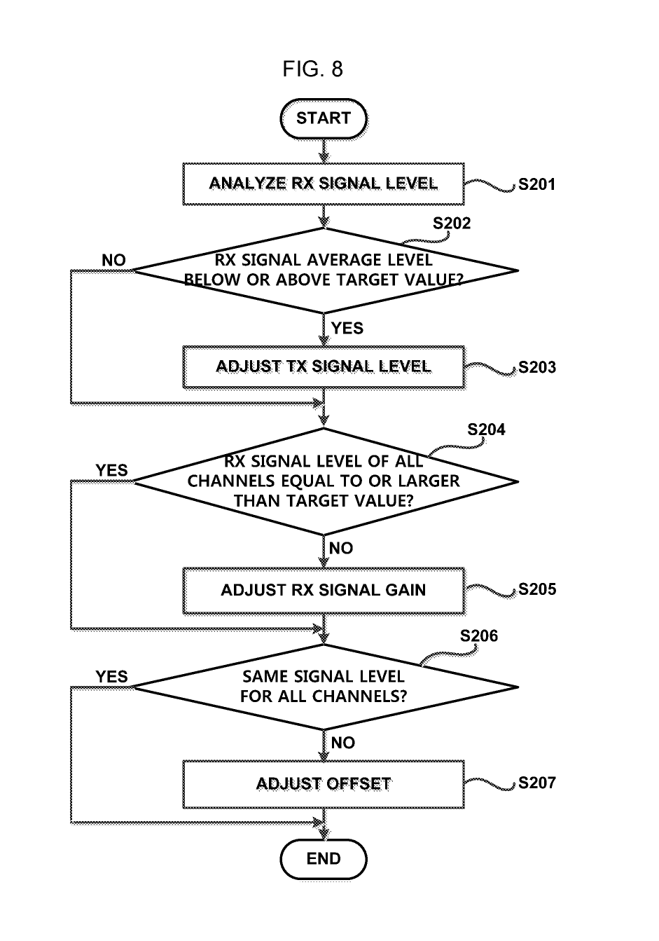

FIG. 8 is a flowchart illustrating an automatic calibration method according to an eighth embodiment of the present invention.

Referring to FIG. 8, the controller 310 analyzes the levels of Rx signals (or Rx signals amplified to a specific level) in operation S201.

The controller 310 may determine whether the average level of the Rx signals is less than or larger than the target value (the first target value) by a value equal to or larger than a predetermined reference according to a result of the analysis (S201) in operation S202.

If the average level of the Rx signals is less than or larger than the target value (the first target value) by a value equal to or larger than the predetermined reference in operation S201 (e.g., according to the result of the analysis), the controller 310 performs Tx signal level adjustment (e.g., Tx signal level calibration) in operation S203.

For example, the controller 310 may calculate the average of the levels of the Rx signals on or over each of the channels, detect one channel outputting an Rx signal closest to the average level, and adjust the level of the Tx signal (e.g., performs the Tx signal level calibration) so that the level of the Rx signal on the detected channel may become the predetermined target value (the first target value).

Also, the controller 310 may measure or analyze the level of an output Tx signal, and if the measured or analyzed level of the Tx signal is not at a target level, may adjust the level of the Tx signal to be at the target level in operation S203, optionally without performing operations S201 and S202.

Meanwhile, the controller 310 determines whether the levels of Rx signals (or Rx signals amplified to a specific level) on all channels are equal to or higher than the predetermined target value (the first target value) in operation S204.

If any of the channels of the Rx signals is less than the target value (the first target value) according to a result of the determination (i.e., NO in operation S204), the controller 310 adjusts the gain of an Rx signal on a channel basis using the Rx signal amplifier 220 in operation S205.

Even when the gain of the Rx signal is adjusted to a maximum value, in the presence of a channel having a level less than the target value (the first target value), the controller 310 may perform the Tx signal level adjustment (e.g., the Tx signal level calibration) again.

On the contrary, if the levels of the Rx signals (or the Rx signals amplified to the specific level) on all channels are equal to or higher than the predetermined target value (the first target value), the controller 310 determines whether the Rx signal of each channel has the same target value (a second target value; e.g., for the same dielectric material, the Rx signal of each channel is attenuated at the same rate and thus has the same Rx signal level) in operation S206.

According to the result of the determination in operation S206, the controller 310 performs offset adjustment (e.g., offset calibration) on an Rx signal channel having a level different from the target value (the second target value) so that the level of the channel may become the target value (the second target value) in operation S207.

As described above, only one type of calibration may be selectively performed, or a specific type of calibration may be omitted, according to an analysis of the levels of the Rx signals. The calibration may be performed aperiodically or on demand (e.g., during booting or banknote introduction, in a standby state, upon input of a user command, or the like) or periodically in various embodiments.

Since calibration of a banknote identification sensor is performed automatically when a banknote detector is booted or a banknote is introduced into the banknote detector, or before the introduced banknote is identified, the accuracy of banknote identification can be increased. Further, the calibration time can be reduced by selectively performing a specific type of calibration based on an analysis of signals (e.g., received signals) from the sensor.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An automatic calibration apparatus comprising:
a transmitter configured to output a transmission signal;
a receiver configured to receive the transmission signal from the transmitter; and
a controller configured to generate the transmission signal at a predetermined frequency to be output by the transmitter, and calibrate the transmission signal by analyzing a signal received by the receiver before banknote identification.

2. An automatic calibration apparatus, comprising:
a transmitter configured to output a transmission signal;
a receiver configured to receive the transmission signal from the transmitter; and
a controller configured to generate the transmission signal at a predetermined level to be output through the transmitter, and calibrate the transmission signal to be at a target level by analyzing a level of the transmission signal output by the transmitter before banknote identification.

3. The automatic calibration apparatus according to claim 1, wherein the controller further performs at least one of gain calibration and offset calibration on each channel of a received signal from the receiver.

4. The automatic calibration apparatus according to claim 2, wherein the controller further performs at least one of gain calibration and offset calibration on each channel of a received signal from the receiver.

5. The automatic calibration apparatus according to claim 1, wherein when an average level of the received signal is lower than a predetermined first target value or higher than the predetermined first target value by a value equal to or larger than a predetermined reference, the controller increases or decreases a level of the transmission signal.

6. The automatic calibration apparatus according to claim 5, wherein when a level of a received signal in or over a channel having a value closest to the average level of the received signal is lower than the predetermined first target value or higher than the predetermined first target value by a value equal to or larger than the predetermined reference, the controller increases or decreases the level of the transmission signal.

7. The automatic calibration apparatus according to claim 1, wherein after calibrating the transmission signal, the controller further performs gain calibration on each channel of the received signal.

8. The automatic calibration apparatus according to claim 7, wherein the gain calibration comprises amplifying each channel of the received signal so that a gain of the channel becomes equal to or higher than the predetermined first target value.

9. The automatic calibration apparatus according to claim 7, wherein after the gain calibration of each channel of the received signal, the controller further performs offset calibration on each channel of the received signal.

10. The automatic calibration apparatus according to claim 9, wherein the offset calibration comprises amplifying each channel of the received signal to have an identical second target value.

11. The automatic calibration apparatus according to claim 9, further comprising a gain amplifier and an offset amplifier, respectively configured to amplify the received signal during the gain and offset calibrations, or an integrated amplifier configured to amplify the received signal during the gain and offset calibrations.

12. An automatic calibration apparatus comprising:
a transmitter configured to output a transmission signal;
a receiver configured to receiving the signal output from the transmitter; and
a controller configured to generate the transmission signal at a predetermined frequency to be output by the transmitter, and perform gain calibration on each channel of a received signal by analyzing the received signal from the receiver before banknote identification.

13. The automatic calibration apparatus according to claim 12, wherein the gain calibration comprises adjusting a gain of each channel of the received signal to have a value equal to or larger than a predetermined first target value.

14. The automatic calibration apparatus according to claim 12, wherein after the gain calibration, the controller further performs offset calibration on each channel of the received signal.

15. The automatic calibration apparatus according to claim 14, wherein the offset calibration comprises adjusting each channel of the received signal to have the same second target value.

16. An automatic calibration apparatus comprising:
a transmitter configured to output a transmission signal;
a receiver configured to receiving the signal output from the transmitter; and
a controller configured to generate the transmission signal at a predetermined frequency to be output by the transmitter, and perform offset calibration on each channel of a received signal by analyzing the received signal from the receiver before banknote identification.

17. The automatic calibration apparatus according to claim 16, wherein when an average level of the received signal is lower than a predetermined first target value or higher than the predetermined first target value by a value equal to or larger than a reference, the controller further performs (i) transmission signal level calibration by increasing or decreasing a level of the transmission signal, or (ii) received signal gain calibration by adjusting a gain of each channel of the received signal to be equal to or larger than the predetermined first target value.

18. An automatic calibration method comprising:
analyzing a level of a signal received from a receiver before banknote identification by a controller; and
calibrating a level of a transmission signal to be output from a transmitter based on an average level of channels of the received signal by the controller.

19. The automatic calibration method according to claim 18, further comprising:
performing at least one of (i) received signal gain calibration by adjusting a gain of each channel of the received signal to have a value equal to or larger than a predetermined first target value, and (ii) offset calibration by adjusting each channel of the received signal to have an identical second target value.

20. The automatic calibration method according to claim 18, wherein calibrating the level of the transmission signal comprises increasing or decreasing the level of the transmission signal when an average level of the received signal is lower than a predetermined first target value or higher than the predetermined first target value by a value equal to or larger than a predetermined reference.

21. The automatic calibration method according to claim 20, wherein when a level in a channel of a received signal having a value closest to the average level of the received signal is lower than the predetermined first target value or higher than the predetermined first target value by a value equal to or larger than the predetermined reference, the level of the transmission signal is increased or decreased.

22. The automatic calibration method according to claim 19, wherein in at least one of the transmission signal level calibration, the received signal gain calibration, and the offset calibration, the controller selects a calibration to be performed first according to whether a banknote detector is booted or not, and/or whether a banknote is sensed or not, and when a current calibration fails, the controller re-performs a previous calibration.
